(19) United States
(12) Patent Application Publication
(10) Pub. No.: US 2007/0209344 A1
(43) Pub. Date: Sep. 13, 2007

(54) Sharpness monitor for indicating turf mower reel blade condition

(75) Inventor: James E. Berkeley, Pineville, NC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/373,873

(22) Filed: Mar. 10, 2006

(51) Int. Cl. A01D 41/14

(52) U.S. Cl. 56/10.2 R

(57) ABSTRACT

A system for notifying the operator of a reel-type greens mower, or any blade-based cutting system, of the relative sharpness of the blades. A controller receives at least one input from the mowing unit such as current draw of the mowing unit, driving energy input to the mowing unit, or rotational speed of the reel, for example, and monitors that input in comparison with the forward cutting speed of the mower to make a determination as to the relative sharpness of the blades. A display may be provided to alert the operator of the condition of the blades, including when maintenance of the blades in necessary. A speed control circuit may also be provided to maintain the speed of the greens mower below the maximum effective cutting speed of the mower.

### FIELD

The present disclosure relates to sharpness monitors and to reel-type turf mowers.

### BACKGROUND

The statements in this section merely provide background information related to the present disclosure and may not constitute prior art.

As is known in the art, reel-type turf mowers are useful for mowing golf course fairways and greens. Golf courses typically require that grass in these areas be cut to exacting standards, and in some cases, such as the putting green areas, to very short lengths. Reel-type turf mowers are well-suited for these applications as they are capable of cutting grass to very short lengths and maintaining a consistent cut. These reel-type mowers can be of the walk-behind or riding variety.

The quality and consistency of the cut of the grass is very important in golf course environments where the play is greatly affected by the length and cut of the grass. The blades will become dull over time, with a corresponding decrease in the ability of the reel-type mower to cut the turf neatly and efficiently. The mower will need to be operated at a slower forward speed to maintain a similar quality of cut if the blade is not sharp, which leads to lengthier lawn maintenance times. It is therefore important that the reel blade cutting elements be well-maintained. The operator must constantly be aware of the relative sharpness of the cutting elements, and sharpen, recondition, or even replace the blades when necessary to prevent poor cut quality. However, it is difficult for the operator to realize exactly when the blades have become dull without first cutting a tract of grass with the dull blade to observe the quality of the cut. It is unlikely that an operator will be able to tell simply by looking at or touching the blades precisely how dull the blades are, or how much life the blades have left before they will require sharpening. Simply sharpening or replacing the blades frequently can also be time-consuming, and may require the inconvenience of increased mower downtime, a decided disadvantage for golf course maintenance crews with short windows of time for lawn maintenance on the course.

Accordingly, there exists a need to provide a reel-type turf mower capable of notifying the operator of the condition or relative sharpness of the blades, when those blades need to be replaced or sharpened, and how much longer the operator can use the blades before they will require sharpening or replacing. In this manner maintenance schedules can be optimized for these types of mowers.

### SUMMARY

According to the principles of the present invention, a walk-behind reel-type mower having an advantageous construction is provided. It should be noted that the present invention is also applicable to ride-on reel-type mowers, rotary mowers, or any other type of mower or blade-based cutting system, and these other embodiments should not be construed as beyond the scope of the present invention. The walk-behind reel-type mower includes a mobile structure and a ground engaging traction member rotatably coupled to the mobile structure for imparting traction movement to the mobile structure for movement on the ground. An electric motor or gas engine is supported on the mobile structure and outputs a driving force at an output shaft. A bed knife is supported by the mobile structure having a cutting edge that cooperates with a grass cutting reel rotatably supported on the mobile structure. The grass cutting reel includes cutting blades being in grass cutting relationship with the bed knife. A drive system is operably coupled between the output shaft and at least one of the ground engaging traction member and the grass cutting reel for transmitting the driving force thereto.

A control system supported by the mobile structure measures the forward speed of the mobile structure, and also the current or driving energy input to the reel-type cutting elements. The control system may also measure other parameters of mower performance that implicate blade wear, such as the rotational speed of the cutting elements. The control system calculates blade wear from an algorithm using these or other inputs, based upon the principle that as the blade becomes more dull, more electric current (for electric reel mowers) or driving energy (for hydraulic reel mowers) must be supplied to the reel or reels to cut similar tracts of grass at similar forward cutting speeds. The control system can thus determine the blade condition by comparing the current draw or driving energy input of the reels with the forward cutting speed of the turf mower over time.

Different lawns will dull the blade at varying rates due to differences in the density of the grass, the height of the uncut grass, moisture level of the soil, etc. Therefore a calibration program may be programmed in the control system for use by the operator on a new tract of grass. The mower would be run over the tract of grass to determine mower performance upon that tract. This effect would then be used by the control system to determine blade wear, along with the aforementioned parameters implicating blade wear. This calibration program would thus adapt the blade wear logic to the various tracts of grass which may be cut.

The control system then relays the blade condition to a display, which can be mounted on the handle or in an otherwise convenient location for the operator to observe, ideally while mowing. An audible or visible alarm may be provided to alert the operator when the blade is reaching certain milestones regarding blade wear, indicating to the operator how worn the blade is, and how much longer the operator may be able to mow until blade maintenance is required. Because the blade wear also impacts the maximum speed at which the mower is effective, a speed control system supported by the mobile structure may also be provided which limits the allowable maximum speed of the turf mower in accordance with the condition of the cutting elements determined by the control system.

It should be noted that this control system can be made to work with a reel-type turf mower with reels powered electrically or hydraulically. The electrically powered reels may be monitored for blade wear by measuring the current draw of the reels compared with the forward cutting speed of the mower, assuming similar tracts of grass are cut. Similarly, hydraulically powered reels will also work with this control system. Instead of an electric current, the driving energy input to the reels is monitored and compared with the forward cutting speed of the mower, again assuming similar tracts of grass are cut.

Further areas of applicability will become apparent from the detailed description provided hereinafter. It should be understood that the detailed description and specific examples are intended for purposes of illustration only and are not intended to limit the scope of the disclosure.

### DRAWINGS

The drawings described herein are for illustration purposes only and are not intended to limit the scope of the present disclosure in any way.

FIG. 1 is a perspective view illustrating a reel-type turf mower according to various embodiments;

FIG. 2 is a block diagram of a sharpness monitor system according to various embodiments;

FIG. 3 is a plot illustrating current draw of a reel-type mower versus the feed rate of a turf mower; and

FIG. 4 is a flow diagram for determining the cutting element condition of a turf mower according to the various embodiments.

### DETAILED DESCRIPTION

The following description is merely exemplary in nature and is in no way intended to limit the invention, its application, or uses. Throughout the specification, like reference numerals will be used to refer to like elements.

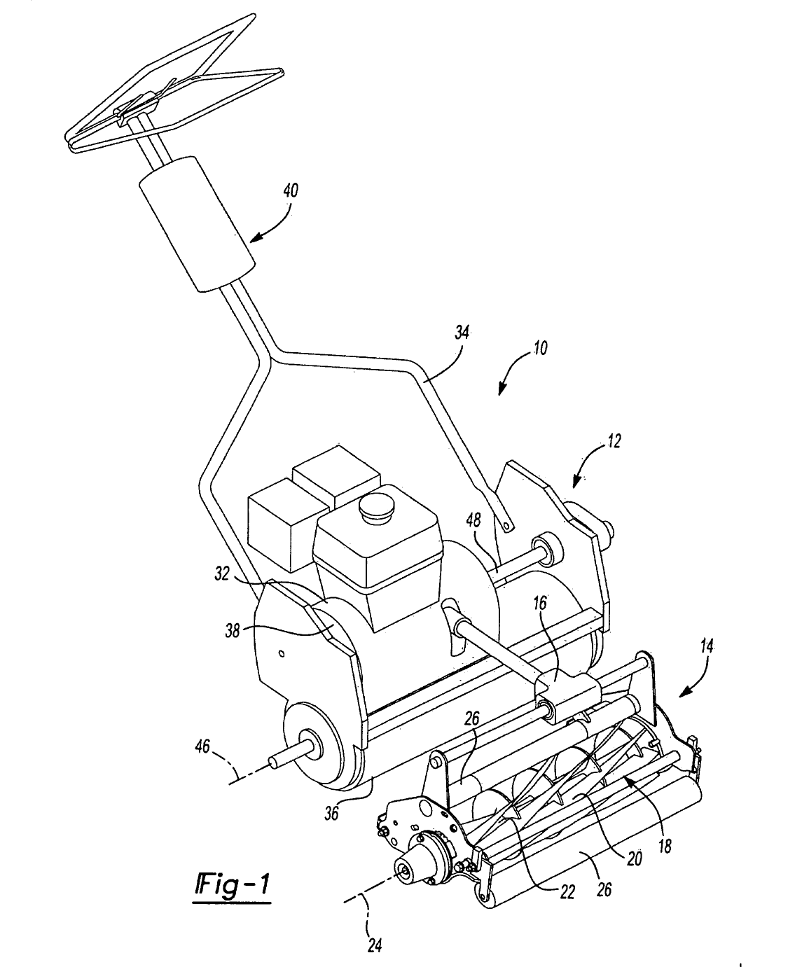

With reference to the figure, FIG. 1 illustrates a greens mower 10 according to various embodiments. Greens mower 10 is a reel-type mower having a base portion 12 and a floating or articulating mowing unit 14. Mowing unit 14 is preferably articulately coupled to base portion 12 through a pivoting mechanism 16. It will be understood by one skilled in the art that the sharpness monitor will be described with respect to a reel mower; however, the present disclosure is equally applicable to other blade-based cutting systems. Such systems include woodworking tools, rotary mowers, and any of a number of various cutting tools.

Mowing unit 14 includes a rotatable greens mower reel 18 having helical blades 20 equally spaced around a reel shaft 22. Reel shaft 22 is generally elongated and defines a rotation axis 24 extending along the length of reel shaft 22. A conventional fixed bed knife (not shown) is operably mounted to mowing unit 14. Blades 20 orbit relative to shaft 22 and move past the fixed bed knife for the usual and well-known function of cutting the grass. Mowing unit 14 further includes a pair of non-driven ground engaging rollers 26 rotatably mounted along a forward and rearward portion of mowing unit 14. The pair of ground engaging rollers 26 serve to support mowing unit 14 for movement on the ground. The pair of ground engaging rollers 26 can be adjustable to define a cutting height. Ground engaging rollers 26 are also equipped with a speed sensor (not shown in FIG. 1) which detects the forward cutting speed of greens mower 10.

Base portion 12 generally includes a gas engine or electric motor 32, a frame 34, a lawn roller 36, a drive system 38, and a handle assembly 40. For the sake of brevity only the electric motor configuration will be discussed herein. However, various embodiments using an internal combustion engine and a hydraulically powered mowing unit 14 are equally applicable. Motor 32 is of conventional design and is mounted on frame 34. A controller (not shown in FIG. 1) is mounted with motor 32 on base portion 12.

Lawn roller 36 is rotatably mounted to frame 34 through a roller axle 46. Lawn roller 36 supports base portion 12 on the ground and serves as the traction drive for greens mower 10. Other ground-supporting traction members could be substituted. Drive system 38 is operably coupled between an output shaft 48 and lawn roller 36. Drive system 38 generally includes a drive pulley (not shown) mounted to output shaft 48 for rotation therewith and an idler pulley (not shown) mounted to lawn roller 36 for rotation therewith. A drive belt (not shown) extends between the drive pulley and the idler pulley to transfer drive force from motor 32 to lawn roller 36. This configuration provides a traction drive train from motor 32 to the ground-engaging lawn roller 36 capable of driving greens mower 10 in at least a forward direction.

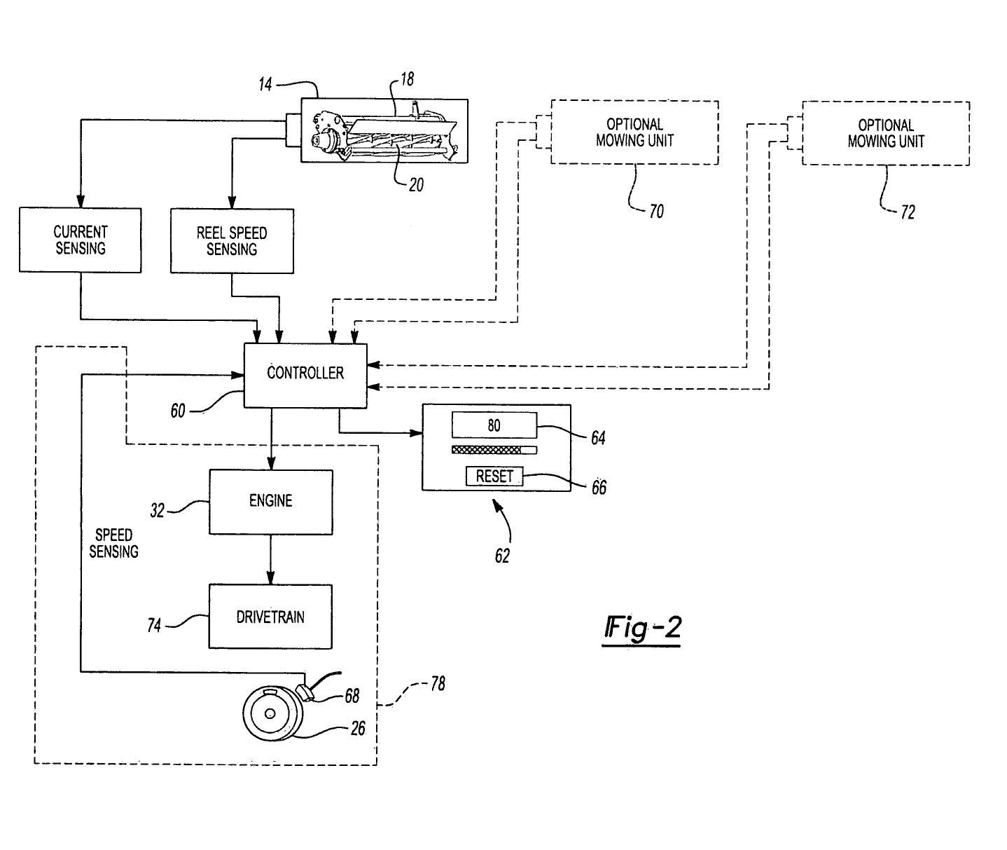

With reference to FIG. 2, controller 60 communicates with mowing unit 14. Although only one mowing unit 14 is shown, it will be understood that one or a plurality of secondary mowing units 70 and 72 shown in phantom may be included in various embodiments without departing from the scope of the invention. Controller 60 is shown receiving signals from mowing unit 14 for sensing current draw and reel speed, and from non-driven ground engaging rollers 26 for sensing the speed of greens mower 10. Controller 60 determines the condition of the reel blades 20 from these inputs, and then communicates signals to display 62 to indicate the determined condition. Controller 60 may optionally receive other inputs that vary in accordance with the condition of blades 20. Display 62 shows the condition of the blades at LED 64 for observation by the operator. Reset button 66 may be provided for resetting a data stored in controller 60 after blades 20 have been reconditioned, sharpened, or replaced. Reset button 66 may be provided at locations to minimize inadvertent activation by the operator or bystanders, such as the back of display 62, or as part of controller 60 itself, for example.

Controller 60 may be integrated with or function cooperatively with speed control circuit 78 for controlling the speed of greens mower 10 in accordance with the condition of blades 20. Controller 60 determines the condition of blades 20 as described above, and determines a maximum allowable speed of greens mower 10. Speed sensor 68 may be positioned adjacent or on non-driven ground-engaging roller 26 to measure the speed of greens mower 10. Controller 60 will then vary the output speed of motor 32 and, consequently, drivetrain 74 if the ground speed of greens mower 10, as determined by speed sensor 68, exceeds the maximum allowable speed. Controller 60 can monitor the speed of greens mower 10 and determine a maximum allowable speed continuously during operation of greens mower 10.

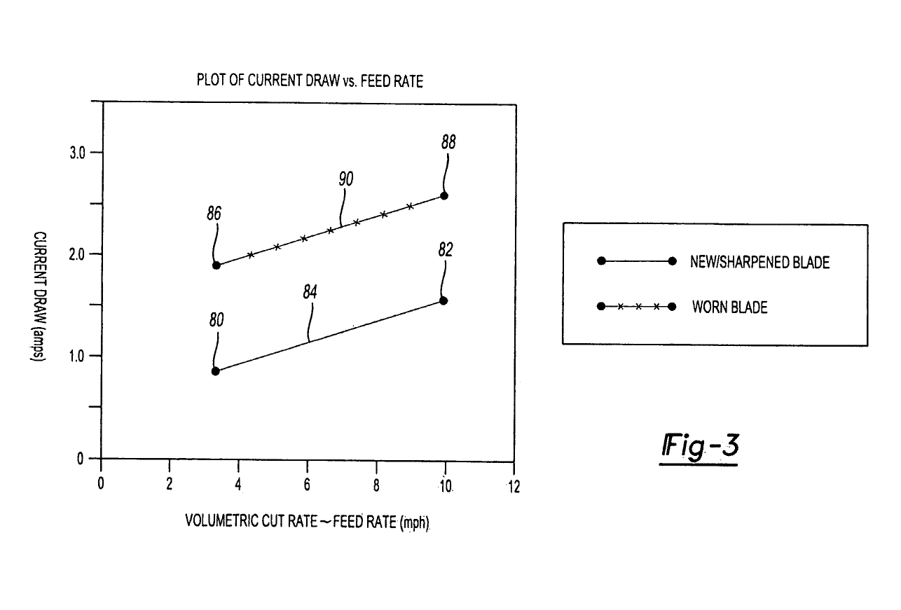

FIG. 3 shows an example graph of the current draw of mowing unit 14 versus the feed rate of greens mower 10. Generally, as the volumetric feed rate of greens mower 10 increases, electric current supplied to mowing unit 14 increases in a generally linear manner in order to maintain an even cut of the grass. As such, when the current draw of mowing unit 14 is plotted against the forward cutting speed of greens mower 10 (which is proportional to the volumetric feed rate of the mower since the width of reel 18 is constant), an approximately straight line 84 results. As the blade becomes less sharp over time through use, more current will be necessary to cut grass at the same speed, for a similar cutting path. Line 90 indicates a plot of current draw versus feed rate for a greens mower cutting a similar path with a worn blade. Controller 60 monitors the current draw of mowing unit 14 and the forward cutting speed of greens mower 10, and determines blade wear accordingly. In some embodiments, other parameters may be measured to determine the wear of reel 18. By way of example, rotational speed of reel 18 is proportional to blade wear over time, similarly as described above. Greater rotational speed requirements of reel 18 to cut similar paths at the same general forward mower speeds indicate blade wear.

A calibration algorithm based upon the principle illustrated by FIG. 3 may also be programmed into or determined by controller 60 as another input for determining blade wear. This may be useful as different strains, mixes, thicknesses, textures, or other characteristics of grass may cause blades 20 to wear at different rates. Greens mower 10 may be programmed at the beginning of each use to be run a set distance at a generally constant speed over a tract of representative grass to be cut. Current draw of mowing unit 14 can be monitored while traveling over the tract of representative grass. Controller 60 can additionally monitor the ground speed or feed rate of greens mower 10. Controller 60 can thus extrapolate a grass density index for the relevant tract of representative grass at the initial blade wear percentage by plotting the current draw observed by controller 60 over the representative tract of grass versus the feed rate. Upon replacement or sharpening of blades 20, the blade life will initially be 100% or, conversely, the blade wear will be at 0%. The condition of blades 20 at the end of any period of use or calibration run may be stored in a memory of controller 60 for retrieval upon the next calibration or use of greens mower 10 on another tract of grass. Current draw and feed rate may subsequently be monitored during use of the mower over similar tracts of grass to calculate wear of blades 20 over time using the memorized blade condition as an initial starting point.

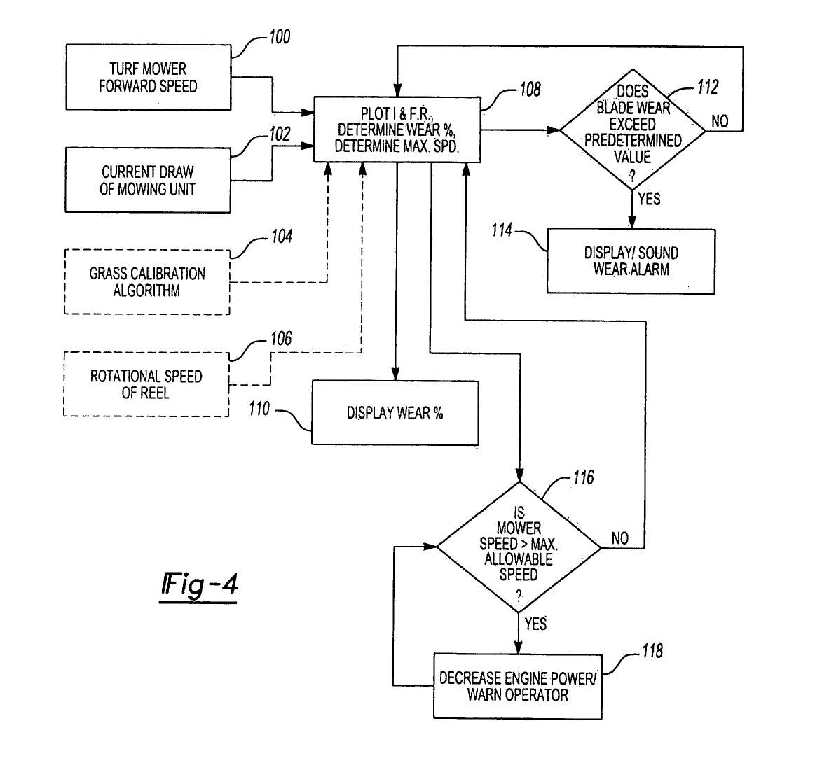

Controller 60 determines the condition of blades 20 from the inputs measured at mowing unit 14 according to an algorithm illustrated in FIG. 4. Input blocks 100 and 102 show the two primary inputs to controller 60, the forward speed 100 of greens mower 10 and the current draw 102 of mowing unit 14. Optional inputs shown in phantom include a grass calibration algorithm 104 and the rotational speed of the reel 106, as described above. At block 108, controller 60 generates a blade wear percentage in accordance with these inputs. This blade wear percentage can then be output to display 62, shown at output block 110. The blade wear percentage is also output to decision block 112, which determines whether the blade wear percentage exceeds a certain predetermined value, representing a condition where the operator should consider or plan to sharpen the blades. This predetermined value may be preset by the manufacturer and adjusted or set by the operator. If the blade wear percentage does exceed a predetermined value, an audible or visible alarm may be triggered at display 62, as shown at block 114. If the blade wear percentage does not exceed the predetermined value, then the process begins again at block 108. Thus, controller 60 constantly monitors the wear of blades 20 and alerts the operator if the blade wear percentage exceeds a predetermined value.

In some embodiments, controller 60 can also include logic to control the speed of greens mower 10 based upon the condition of blades 20. A maximum allowable speed for greens mower 10 is determined by controller 60 at block 108 from the inputs described above. At decision block 116 this maximum allowable speed is compared with the actual speed of greens mower 10 as determined by speed sensor 68. If the actual speed of greens mower 10 does exceed the maximum allowable speed as determined by controller 60, block 118 directs controller 60 to decrease the output speed of motor 32. Other methods of decreasing the speed of greens mower 10 may be utilized. This cycle continues, thus continuously comparing the actual speed of greens mower 10 with the maximum allowable speed as continuously adjusted by controller 60.

The description of the invention is merely exemplary in nature and, thus, variations that do not depart from the gist of that which is described are intended to be within the scope of the disclosure. Such variations are not to be regarded as a departure from the spirit and scope of the disclosure.

What is claimed is:

1. A turf mower comprising:
a ground speed sensor, the ground speed sensor determining a ground speed of the turf mower;
a reel-type cutting unit supported by the turf mower, the reel-type cutting unit being electrically powered and including a cutting element;
a current sensor, the current sensor determining an electric current supplied to drive the cutting element; and
a controller communicating with the ground speed sensor and the current sensor, the controller determining a condition of the cutting element in accordance with at least one of the turf mower ground speed and the electric current supplied to drive the cutting element.

2. The turf mower of claim 1 wherein the ground speed sensor senses the speed of a non-driven wheel supporting the turf mower.

3. The turf mower of claim 1 wherein the condition to be determined by the controller is the sharpness of the cutting element.

4. The turf mower of claim 1 wherein the controller comprises a microprocessor.

5. The turf mower of claim 4 wherein the determined condition of the cutting element determined by the controller can be reset.

6. The turf mower of claim 1 further comprising a display, the display receiving a signal from the controller that varies in accordance with the condition of the cutting element.

7. The turf mower of claim 1, further comprising a reel speed sensor, the reel speed sensor determining a rotational speed of the cutting element and communicating with the controller, the controller determining a condition of the cutting element in accordance with at least one of the turf mower ground speed, the electric current supplied to drive the cutting element, and the rotational speed of the cutting element.

8. The turf mower of claim 1, wherein the controller applies a calibration algorithm to determine a condition of the cutting element in accordance with at least one of the turf mower ground speed and the electric current supplied to drive the cutting element.

9. The turf mower of claim 1 wherein the controller limits the maximum allowable speed of the turf mower in accordance with the condition of the cutting element.

10. A turf mower comprising:
means for determining a ground speed of the turf mower;
an electrically powered reel-type cutting unit supported by the turf mower, the reel-type cutting unit including a cutting element;
means for determining an electric current supplied to drive the cutting element; and
control means communicating with the turf mower ground speed determining means and the cutting element current determining means, the control means determining a condition of the cutting element in accordance with at least one of the turf mower ground speed and the electric current supplied to drive the cutting element.

11. The turf mower of claim 10 wherein the means for determining turf mower ground speed senses the speed of a non-driven wheel supporting the turf mower.

12. The turf mower of claim 10 wherein the condition to be determined by the control means is the sharpness of the cutting element.

13. The turf mower of claim 10 wherein the control means comprises a microprocessor.

14. The turf mower of claim 13 wherein the determined condition of the cutting element determined by the control means can be reset.

15. The turf mower of claim 10 further comprising a display, the display receiving a signal from the control means that varies in accordance with the condition of the cutting element.

16. The turf mower of claim 10, further comprising a means for determining a rotational speed of the cutting element in communication with the control means, the control means determining a condition of the cutting element in accordance with at least one of the turf mower ground speed, the electric current supplied to drive the cutting element, and the rotational speed of the cutting element.

17. The turf mower of claim 10, wherein the control means applies a calibration algorithm to determine a condition of the cutting element in accordance with at least one of the turf mower ground speed and the electric current supplied to drive the cutting element.

18. The turf mower of claim 10, wherein the control means limits the maximum allowable speed of the turf mower in accordance with the condition of the cutting element.

19. A method for determining a condition of a cutting element of a reel-type cutting unit of a turf mower comprising:
determining a ground speed of the turf mower;
determining a current supplied to drive the cutting element; and
determining a condition of the cutting element in accordance with at least one of the ground speed of the turf mower and the current supplied to the cutting element.

20. The method of claim 19 further comprising providing a sensor at a non-driven wheel supporting the turf mower to determine the ground speed of the turf mower.

21. The method of claim 19 wherein the determined condition of the cutting element is the sharpness of the cutting element.

22. The method of claim 19, further comprising communicating the condition of the cutting element to the operator.

23. The method of claim 19, further comprising communicating the condition of the cutting element to the operator through a data display.

24. The method of claim 19 further comprising determining a rotational speed of the cutting element, the condition of the cutting element being determined from at least one of the ground speed of the turf mower, the current supplied to drive the cutting element, and the rotational speed of the cutting element.

25. The method of claim 19, further comprising applying a calibration algorithm to determine the condition of the cutting element from at least one of the ground speed of the turf mower and the current supplied to drive the cutting element.

26. The method of claim 19, further comprising limiting the maximum allowable speed of the turf mower in accordance with the condition of the cutting element.

27. A turf mower comprising:
a ground speed sensor, the ground speed sensor determining a ground speed of the turf mower;
a cutting unit supported by the turf mower, the cutting unit including a cutting element;
a driving energy sensor, the driving energy sensor determining a driving energy supplied to the cutting element; and
a controller communicating with the ground speed sensor and the driving energy sensor, the controller determining a condition of the cutting element in accordance with at least one of the turf mower ground speed and the driving energy supplied to the cutting element.

28. The turf mower of claim 27 wherein the ground speed sensor senses the speed of a non-driven wheel supporting the turf mower.

29. The turf mower of claim 27 wherein the condition to be determined by the controller is the sharpness of the cutting element.

30. The turf mower of claim 27 wherein the controller is an electronic controller, including a microprocessor.

31. The turf mower of claim 30 wherein the determined condition of the cutting element determined by the electronic controller can be reset.

32. The turf mower of claim 27 further comprising a display, the display receiving a signal from the controller that varies in accordance with the condition of the cutting element.

33. The turf mower of claim 27, further comprising a cutting element speed sensor, the cutting element speed sensor determining a rotational speed of the cutting element and communicating with the controller, the controller determining a condition of the cutting element in accordance with at least one of the turf mower ground speed, the driving energy supplied to the cutting element, and the rotational speed of the cutting element.

34. The turf mower of claim 27 wherein the controller implements an algorithm to determine a condition of the cutting element in accordance with at least one of the turf mower ground speed and the driving energy supplied to the cutting element.

35. The turf mower of claim 27 wherein the controller limits the maximum allowable speed of the turf mower in accordance with the condition of the cutting element.

36. The turf mower of claim 27 wherein the cutting unit is hydraulically powered.

37. A material removal apparatus comprising:
a cutting unit including a cutting element;
a driving energy sensor, the driving energy sensor determining a driving energy supplied to the cutting element;
a speed sensor determining a material feed rate of the cutting unit; and
a controller communicating with the speed sensor and the driving energy sensor, the controller determining a condition of the cutting element in accordance with at least one of the cutting unit feed rate and the driving energy supplied to the cutting element.

38. The material removal apparatus of claim 37 wherein the speed sensor senses the speed of a non-driven wheel supporting the material removal apparatus.

39. The material removal apparatus of claim 37 wherein the condition to be determined by the controller is the sharpness of the cutting element.

40. The material removal apparatus of claim 37 wherein the controller comprises a microprocessor.

41. The material removal apparatus of claim 40 wherein the determined condition of the cutting element determined by the electronic controller can be reset.

42. The material removal apparatus of claim 37 further comprising a display, the display receiving a signal from the controller that varies in accordance with the condition of the cutting element.

43. The material removal apparatus of claim 37, further comprising a cutting element speed sensor, the cutting element speed sensor determining a rotational speed of the cutting element and communicating with the controller, the controller determining a condition of the cutting element in accordance with at least one of the cutting unit feed rate, the driving energy supplied to the cutting element, and the rotational speed of the cutting element.

44. The material removal apparatus of claim 37 wherein the controller implements a material calibration algorithm to determine a condition of the cutting element in accordance with at least one of the cutting unit feed rate and the driving energy supplied to the cutting element.

45. The material removal apparatus of claim 37 wherein the controller limits the maximum allowable speed of the material removal apparatus in accordance with the condition of the cutting element.
